(19) United States
(12) Patent Application Publication
(10) Pub. No.: US 2007/0133594 A1
(43) Pub. Date: Jun. 14, 2007

(54) Method and system for delivering a message in a communication network

(76) Inventors: Rajesh S. Pazhyannur, Lake Zurich, IL (US); Jay R. Almaula, Bartlett, IL (US); Anwar M. Haneef, Streamwood, IL (US); Jayanth P. Mysore, Streamwood, IL (US); Venugopal Vasudevan, Palatine, IL (US); Narayanan Venkitaraman, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/296,619

(22) Filed: Dec. 7, 2005

(51) Int. Cl. H04J 3/22; H04J 3/18

(52) U.S. Cl. 370/465; 370/477

(57) ABSTRACT

A method for delivering a message to a user in a communication network (100) is disclosed. The method includes monitoring (402) an environment of the user. The method further includes delivering (404) the message to the user in a plurality of stages. The plurality of stages is determined based on the environment of the user.

### FIELD OF THE PRESENT INVENTION

This invention relates in general to communication networks, and more specifically to delivery of messages in a communication network.

### BACKGROUND OF THE PRESENT INVENTION

A communication network includes a plurality of devices capable of interacting with each other. Examples of the communication network include an Internet, a Local Area Network (LAN), a Code Division Multiple Access (CDMA) network, a Global System for Mobile Communications (GSM) network, and the like. Examples of the devices include electronic devices such as mobile phones, pagers, computers, laptops, PDAs and the like.

Each of the plurality of devices in the communication network may support different types of message formats. Further, each of the plurality of devices may be reachable from different types of networks at different points in time. The different types of networks may support different speeds for data transfer. It may not be possible to send a message of very large size to the device when it is reachable from a network supporting a low speed of data transfer. Thus, the device may sometimes not be able to receive the message destined for the device.

There exist various methods that allow a user to receive the message in dynamic environments. One such method includes duplication of the message transmission to multiple devices. The message is sent to all the devices being used by the user. Another method includes transforming the message into a type supported by the device being used by the user. Yet another method includes delaying the delivery of the message based on pre-defined criteria. In this method, when the size of the message is greater than a pre-defined size then the message is delivered only when the device is reachable from a specific type of network. Another method includes notifying the user about the message when the device does not support the type of message.

However, the methods described above have several limitations. Previous methods do not enable a user to specify his or her preferences for delivery of the message. Previous methods require a greater degree of interaction with the user when the type of network or the type of device, being used by the user, changes. Also, previous methods do not alter message delivery based on factors such as device availability, network conditions, and user status. Rather, message delivery is altered in previous methods by sending different components of the original message to different devices at different times.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate the embodiments and explain various principles and advantages, in accordance with the present invention.

FIG. 1 represents an exemplary environment, where various embodiments of the present invention may be practiced;

FIG. 2 is a block diagram illustrating the interaction between a server and a device, in accordance with an embodiment of the present invention;

FIG. 3 is a block diagram illustrating the components of a messaging server, in accordance with an embodiment of the present invention;

FIG. 4 is a flow chart illustrating a method for delivering a message in a communication network, in accordance with an embodiment of the present invention;

FIG. 5 is a flow chart illustrating a method for delivering a message to a user in a communication network, in accordance with an embodiment of the present invention;

FIG. 6 is a flow chart illustrating a method for delivering pending stages of a message to a user in a communication network, in accordance with an embodiment of the present invention; and

FIG. 7 is a flow chart illustrating a method for deleting a message from a plurality of devices in a communication network, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

Before describing in detail embodiments that are in accordance with the present invention, it should be observed that the embodiments reside primarily in combinations of method steps and apparatus components related to delivery of a message in a plurality of stages in a communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The present invention describes a method for delivering a message to a user in a communication network. The method includes monitoring the environment of the user of a device and sending the message to the user in a plurality of stages. The plurality of stages is determined based on the environment of the user.

The present invention also describes a system for delivering a message to a user in a communication network. The system includes a user state manager and a messaging server. The user state manager monitors an environment of the user in the communication network. The messaging server delivers the message to the user in a plurality of stages.

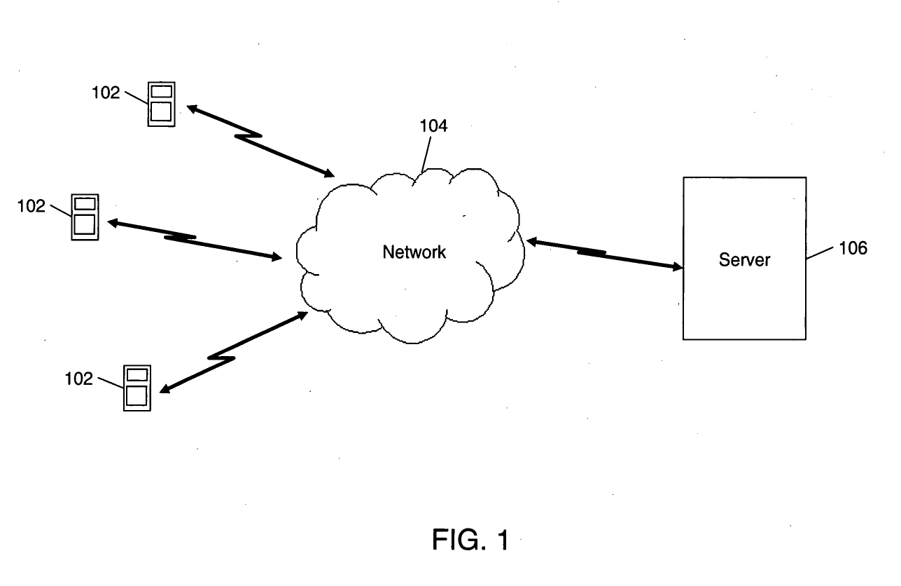

FIG. 1 represents an exemplary environment in which various embodiments of the present invention can be practiced. A communication network 100 includes a plurality of devices 102, a network 104 and a server 106. The plurality of devices 102 has hereinafter been referred to as devices 102. The devices 102 enable users to communicate among themselves. The communication can be in the form of a voice mail, a voice message, a text message, a video mail, a combination of voice, text and video, and the like. Examples of the device 102 include a mobile phone, a pager, a computer, a laptop, a satellite phone, and the like. The devices 102 are linked to the server 106 through the network 104. The network 104 enables exchange of data between the devices 102 and the server 106. Examples of the network 104 include a high-speed network, a broadband network, and a low-speed network. The high-speed network may include an optical fiber based internet, a Local Area Network (LAN), a Wide Area Network (WAN), and the like. The broadband network may include Internet via a Very Small Aperture Terminal (VSAT), and the like. The low-speed network may include a Code Division Multiple Access (CDMA) network, a Global System for Mobile Communications (GSM) network, and the like. The server 106 controls and manages sending and receiving procedures of the message, handles protocols, transforms the message, keeps track of the environment of the user of the device 102 and determines rules for staging the message. Staging a message involves breaking the message into various components based on user-defined rules. Staging a message involves transmitting either the message or a transformed message at different instants of time such that each stage differs from the previous stage. For example, in one stage, a part of the message is delivered to a device. In the next stage, the rest of the message is transformed and is delivered to a new device. In various embodiments of the present invention, the environment of the user of the device 102 includes a device characteristic, a device capability, type of the network, a location of the user of the device 102 and an availability status of the user of the device 102. The device characteristic may include type of device being used by a user. The device capability may include the memory of the device, the computational power of the device, the size of the display and the type of screen. The device capability may also include specifications of graphic capability, video capability, sound capability, and display capability. The location of the user of the device 102 may be determined by his presence at home, office, car and the like. Examples of the availability status of the user may include in-meeting, driving, sleeping, busy, out-for-lunch, and the like.

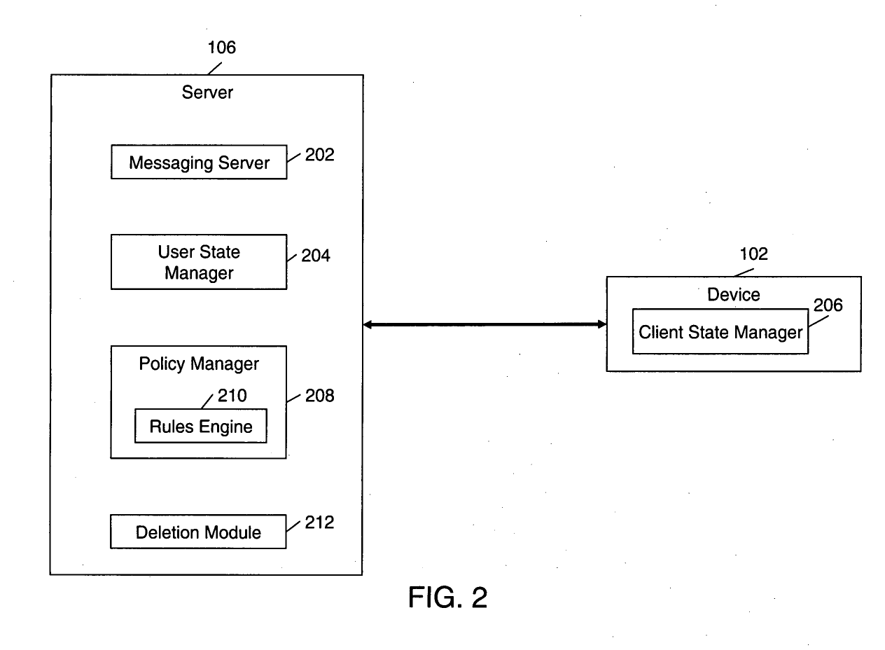

FIG. 2 depicts the interaction between the device 102 and the server 106, in accordance with an exemplary embodiment of the present invention. The server 106 includes a messaging server 202 and a user state manager 204. The messaging server 202 receives a message from a device in the communication network 100. The message is to be sent to the device 102. The device 102 includes a client state manager 206, which monitors the environment of the user of the device 102. The client state manager 206 sends the information regarding the environment to the user state manager 204. The messaging server 202 delivers the message to the user based on the information received from the client state manager 206. The message may be delivered in a plurality of stages based on the information received from the client state manager 206.

In an embodiment of the present invention, the information, received from the client state manager 206 is used by a policy manager 208 for deciding a policy for delivering the message. The policy manager 208 compares the information with a pre-defined set of rules. In an embodiment of the present invention, the pre-defined set of rules is stored in a rules engine 210 in the policy manager 208. The policy manager 208 may compare the information regarding the environment with a policy profile of the user of the device 102. The policy profile of the user is maintained in the policy manager 208. The policy profile may include preferences of the user of the device 102, such as delivering a particular type of message when the user is reachable from a specific type of network. For example, the preference may be that a video mail should be delivered when the user of the device 102 is reachable from a high-speed network. In another example, the preference may be that when the user is driving a vehicle, only a voice message should be delivered. Based on the comparison, the policy manager 208 intimates the messaging server 202 to stage the message in a plurality of stages and deliver one of the plurality of stages to the device 102.

In an embodiment of the present invention, when a message is delivered in a plurality of stages, the messaging server 202 maintains a list of a plurality of devices to which each of the plurality of stages has been delivered. Each of the plurality of the stages has hereinafter been referred to as an instance of the message. When a user selects to delete a message, a deletion module 212, in the server 106, signals the messaging server 202. Based on the list of the plurality of devices, the messaging server 202 deletes the instances of the message from each of the plurality of devices.

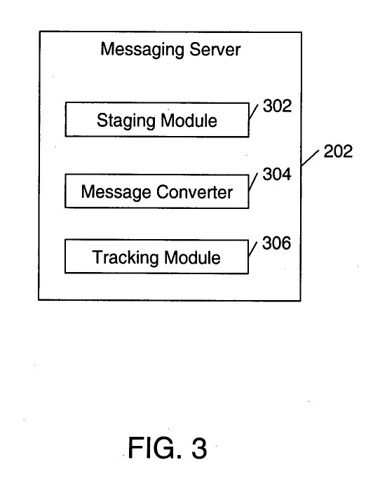

FIG. 3 is a block diagram of the messaging server 202, in accordance with an embodiment of the present invention. The messaging server 202 includes a staging module 302, a message converter 304 and a tracking module 306. Based on the intimation from the policy manager 208, the staging module 302 determines the number of stages into which the message should be delivered. Before delivering the message, the message converter 304 may transform the message from a first form to a second form based on the intimation from the policy manager 208. For example, a voice message may be converted into a text message. While delivering the message in the plurality of stages, the tracking module 306 maintains a list of devices to which the instances of the message were delivered. Each instance of the message corresponds to each stage of the message. The list of devices maintained by the tracking module 306 can be used when the user wants to delete a message from the device 102.

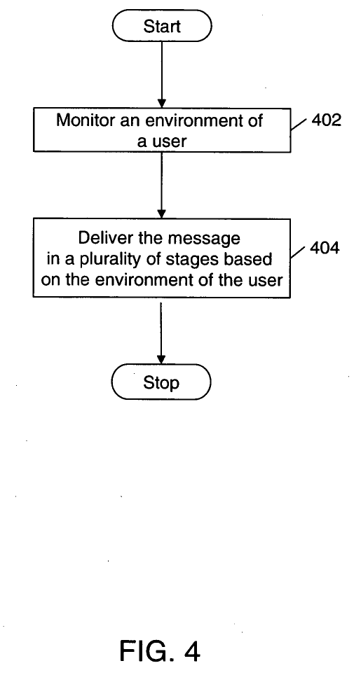

FIG. 4 is a flowchart illustrating a method for delivering a message in the communication network 100, in accordance with an embodiment of the present invention. The server 106 receives the message from a first device in the communication network 100. At step 402, the environment of the user of the device 102 is monitored. The user state manager 204 monitors the environment of the user of the device 102, in accordance with an embodiment of the present invention. The client state manager 206 in the device 102 gathers information regarding the location of the user, characteristic of the device 102, capability of the device 102 and the availability status of the user. The client state manager 206 sends the gathered information to the user state manager 204. At step 404, the message is delivered to the user in a plurality of stages. The messaging server 202 delivers each instance of the message to each of the plurality of devices being used by the user. The plurality of stages is determined based on the environment of the user of the device 102. Then the stages of the message are delivered to the user based on the preference of the user.

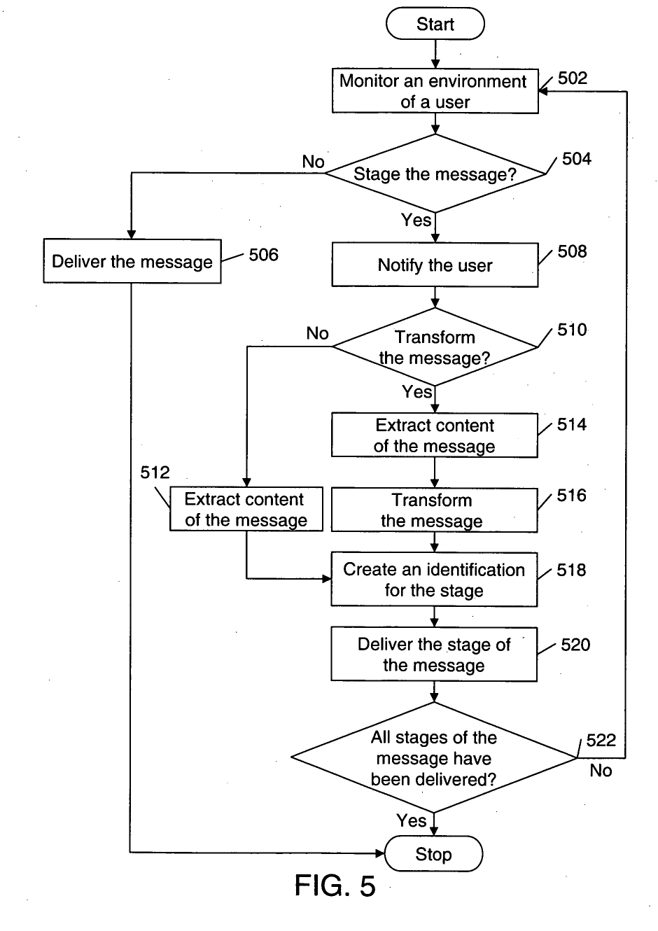

FIG. 5 is a flowchart illustrating a method for delivering a message to a user in the communication network 100, in accordance with another embodiment of the present invention. The user of a first device sends the message to the device 102. The messaging server 202 receives the message. At step 502, the environment of the user of the device 102 is monitored. The client state manager 206, in the device 102, gathers information regarding the environment. The information may include the characteristic of the device 102, the capability of the device 102, the availability of the user of the device 102, the location of the user of the device 102 and the type of network being used by the user. The client state manager 206 sends the gathered information to the user state manager 204. At step 504, it is determined whether the message has to be staged or not. The policy manager 208 determines this based on the information received from the client state manager 206 and the pre-defined set of rules stored in the rules engine 210. The policy manager 208 may decide to deliver the message as it is or delay the message or stage the message based on the pre-defined set of rules and the preferences of the user. If the message does not need to be staged or delayed at step 504, the message is delivered to the user at the step 506. Otherwise, step 508 is performed. At step 508, the user of the device 102 is notified about the message. The user may be notified about the message through a Short Messaging Service (SMS) message, a Multimedia Messaging Service (MMS) message, e-mail, and the like.

Further at step 510, it is determined whether the message should be transformed. The message is transformed if the device 102 does not support the format of the message. The message may also be transformed based on the preferences of the user and the set of rules. For example, if the message is a voice message and the device 102 is reachable from a low-speed network, the pre-defined set of rules may specify delivery of the message only when the device 102 is reachable from a high-speed network. The policy manager 208 may decide to transform the voice message into a text message. In another example, the message is a text message and the user is logged on to the communication network 100 using the device 102 while driving a vehicle. The preferences of the user may include delivering only a voice message when the user is driving. The policy manager 208 may decide to transform the text message into a voice message. If the policy manager 208 decides not to transform the message, step 512 is performed. At step 512, a portion of the message is extracted. In accordance with an embodiment of the present invention, the messaging server 202 extracts a portion of the message. For example, if the user can hear only audio messages on the device 102, an audio portion is extracted from a video message. Similarly, a picture, an audio portion or a text portion may be extracted from a multimedia message.

If the message needs to be transformed, step 514 is performed. At step 514, a portion of the message is extracted. In accordance with an embodiment of the present invention, the messaging server 202 extracts a portion of the message depending upon the environment of the user. At step 516, the extracted portion of the message is transformed into another form. The message is transformed by the message converter 304. For example, the messaging server 202 may extract the audio portion from a video message. The extracted audio portion can be converted into the text message by the message converter 304.

After step 512 or step 516, step 518 is performed. At step 518, a unique identification for the stage of the message is created. The unique identification is attached with an instance of the message to be delivered in the stage. The tracking module 306 maintains a list of messages delivered and their corresponding unique identifications. The messaging server 202 attaches a unique identification to each instance of the message. At step 520, the instance of the message is delivered to the device 102. The messaging server 202 delivers the stage of the message to the user based on the user preference. The messaging server 202 maintains a list of devices to which the instance of the message is delivered. Further, at step 522, it is checked if all stages of the message have been delivered. If all the stages have been delivered the method terminates. Otherwise, step 502 is performed again.

In an embodiment of the present invention, the user of the device 102 may have specified that while the user of the device 102 is driving a vehicle, only a voice mail or a voice message should be delivered. In such a case, the policy manager 208 ensures extraction of an audio content from the video message before delivering the message. The audio content is extracted from the video message to be delivered. The extracted audio content is delivered to the user as a voice message. In another example, the user of the device 102 may have specified that a video message should be delivered only when the device 102 is reachable from a high-speed network. The policy manager 208 ensures delivery of the message only when the device 102 is reachable from the high-speed communication network. The message converter 304 transforms the extracted portion into another form. For example, the audio portion of the message may be converted into a text message or a text portion of the message may be converted into a voice mail or a voice message. It will be recognized that methods of converting a message from one form to another are well known to those skilled in the art. Thus, details of such methods are not described herein. In an embodiment of the present invention, a video message may not be delivered to the user, if the user is using a low speed network. The messaging server 202 may notify the user that a video message has been received. The video message may be delivered when the user is reachable from a high-speed network.

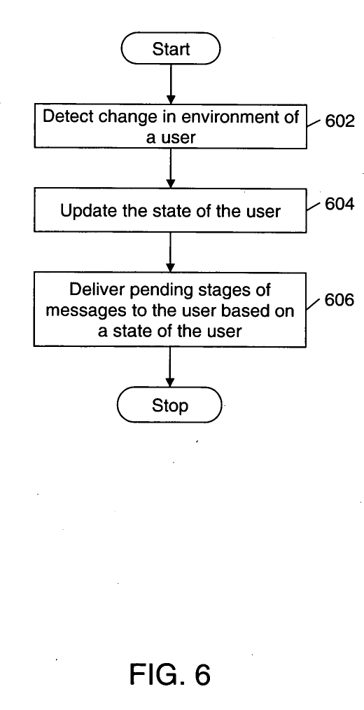

FIG. 6 is a flowchart illustrating a method for delivering pending stages of a message to the user of the device 102, in accordance with another embodiment of the present invention. This method is executed when there is a change in the environment of the user of the device 102. For example, consider that the user starts using a mobile phone instead of a laptop. In another example, the user of the device 102 may move to a high-speed network from a network with a lower speed of data transfer. In another example, there may be a change in the environment of the user of the device 102 due to change in location, and the like. At step 602, a change in environment of the user is detected. The client state manager 206 detects the change in the environment of the user. At step 604, the state of the user is updated. The client state manager 206 informs the policy manager 208 via the user state manager 204 about a change in the environment of the user. The policy manager 208 checks for pending stages of the message to be delivered to the user. At step 606, pending stages of the message are delivered to the user. Consider a case when the user of the device 102 is reachable from the low-speed network and the message is a video message. An audio portion extracted from the video message is delivered as a text message. The pending stage of the message is the video part of the message. When the user of the device 102 is reachable from a high-speed network, the audio and video part of the message is delivered.

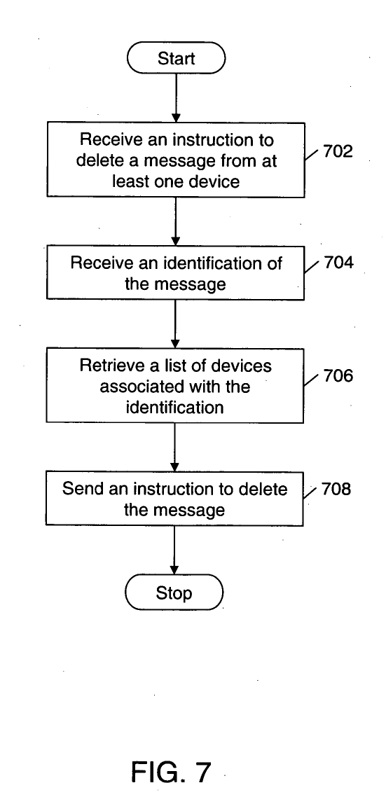

FIG. 7 shows a flowchart illustrating a method for deleting a message from at least one device from a plurality of devices in the communication network 100, in accordance with an embodiment of the present invention. At step 702, an instruction is received from a user to delete a message from at least one device. The messaging server 202 receives the instruction form the user to delete the message. At step 704, an identification of the message is received. The messaging server 202 receives the identification of the message from the tracking module 306. At step 706, a list of devices associated with the identification is retrieved. The messaging server 202 retrieves the list of devices from the tracking module 306. Thereafter, at step 708, an instruction along with the identification is send to the at least one device to delete the message. The deletion module 212 instructs the at least one device to delete the instances of the message. In an embodiment of the present invention, the deletion module 212 can enable deletion of all the instances of the message automatically after a predefined time period.

In an embodiment of the present invention, a message is sent from a first device to a user of the device 102. The messaging server 202 receives the message from the user of the first device. The user of the device 102 may have specified the preferences for delivering the message. The preferences may include characterizing the locations, characterizing the availability status, and the like. The locations may include an office location, a home location, an auto location, a mobile location, and the like. Each of the locations is characterized by the type of devices and the type of network being used at each of the locations. The user of the device 102 may have specified the type of the device and the type of the network corresponding to each of the locations. The office location may indicate use of a laptop or a general-purpose computer reachable from a high-speed network. The home location may indicate use of a laptop or a general-purpose computer reachable from a broadband network. The auto location may indicate use of a mobile phone or a satellite phone reachable from a network with a low speed of data transfer. The mobile location may indicate any environment except those mentioned above. The laptop and the computer may be capable of receiving e-mail, a video mail, a voice mail, a text message, an SMS, an MMS and the like. The mobile phone and the satellite phone may be capable of receiving an e-mail, an SMS and an MMS but may not be capable of receiving large messages such as a video mail, a voice mail, and the like. The availability status of the user may include a driving mode, a sleeping mode, a meeting mode, and the like. The driving mode may characterize that the user can receive only an audio portion of a message as a voice mail or a voice message. The meeting mode and the sleeping mode may characterize that the user is busy. The user may not receive any instance of the message. The policy manager 208, which maintains the policy profile for the user, may compare the environment of the user with the pre-defined set of rules and the preferences of the user.

The present invention provides a method and system for delivering a message in the plurality of stages to the user in the network. The method and system allows the user to receive the message in a plurality of stages based on preferences of the user. The method enables the user to receive the message while effortlessly switching among multiple devices in multiple networks.

The instant specification is provided to further explain in an enabling manner the best modes of making and using various embodiments, in accordance with the present invention. The specification is also given to enhance the perception and appreciation of the inventive principles and advantages thereof, rather than to limit in any manner the present invention. The present invention is defined solely by the appended claims, including any amendments made during the pendency of this application and all equivalents of the claims, as issued.

This specification is intended to elaborate on how to fashion and use various embodiments, in accordance with the present invention, rather than limit the true, intended, fair scope and spirit thereof. The foregoing description is not intended to be exhaustive or limit the present invention to the precise forms disclosed. Modifications or variations are possible in light of the above teachings. The embodiment was chosen and described, to provide the best illustration of the principles of the present invention and its practical application to enable one with ordinary skill in the art to utilize the present invention in various embodiments and with various modifications, as are suited to the particular use contemplated. All such modifications and variations are within the scope of the present invention, as determined by the appended claims, which may be amended during the pendency of this application for patent, and all equivalents thereof, when interpreted in accordance with the breadth to which they are fairly, legally and equitably entitled.

What is claimed is:

1. A method for delivering a message to a user in a communication network, the method comprising:
monitoring an environment of the user; and
delivering the message to the user in a plurality of stages, the plurality of stages being determined based on the environment of the user.

2. The method of claim 1, wherein monitoring the environment comprises monitoring at least one of: a device characteristic, a device capability, a network bandwidth, a user location and a change in user availability.

3. The method according to claim 1, wherein delivering the message to the user comprises determining a content of the message to be delivered at each of the plurality of stages.

4. The method according to claim 1, wherein delivering the message to the user comprises determining the devices to be used in each of the plurality of stages.

5. The method according to claim 1 further comprising maintaining a policy profile of the user.

6. The method according to claim 1 further comprising transforming the message from a first form to a second form based on the environment of the user.

7. The method of claim 1 further comprising creating an identification for each stage of the message.

8. The method according to claim 7, wherein creating the identification comprises attaching a unique identification with each of the plurality of instances of the message.

9. The method according to claim 1 further comprising maintaining a list of devices to which the plurality of instances of the message is delivered.

10. The method according to claim 1 further comprising delaying the delivering of the message based on the environment of the user.

11. The method according to claim 10 further comprising notifying the user about delaying the delivering of the message.

12. A method for deleting a message from at least one device from the plurality of devices in a communication network, the method comprising:
receiving instruction from a user to delete the message from the at least one device;
receiving an identification of the message;
retrieving a list of devices associated with the identification; and
sending an instruction to delete the message along with the identification to the at least one device.

13. A system for delivering a message to a user in a communication network, the system comprising:
a user state manager capable of monitoring an environment of the user in the communication network; and
a messaging server capable of delivering the message to the user in a plurality of stages.

14. The system according to claim 13, wherein the messaging server comprises a staging module capable of determining the number of stages into which a message should be delivered.

15. The system according to claim 13, wherein the messaging server further comprises a message converter capable of transforming the message.

16. The system according to claim 13, wherein the messaging server further comprises a tracking module capable of maintaining a list of devices to which instances of the message are delivered.

17. The system according to claim 13 further comprising a policy manager for maintaining a policy profile for the user.

18. The system according to claim 17, wherein the policy manager comprises a rules engine for determining rules for delivering the message.

19. The system according to claim 13 further comprising a deletion module capable of signaling the messaging server to delete a message.

20. The system according to claim 13 further comprising a client state manager for communicating the environment of the user to the user state manager.

21. The system according to claim 13, wherein the environment comprises at least one of a device characteristic, a device capability, a network bandwidth, a user location and a change in user availability.
